(19) United States
(12) Patent Application Publication
(10) Pub. No.: US 2022/0297270 A1
(43) Pub. Date: Sep. 22, 2022

(54) Driver Having Helical Toothed Blades

(71) Applicant: William Norton, West Pittston, PA (US)

(72) Inventor: William Norton, West Pittston, PA (US)

(21) Appl. No.: 17/204,985

(22) Filed: Mar. 18, 2021

(51) Int. Cl. B25B 15/00

(52) U.S. Cl. CPC B25B 15/005

(57) ABSTRACT

A driver for threaded fasteners has helical blades with engagement surfaces on one side and teeth on an opposite side. The engagement surfaces engage surfaces within the recesses in the fastener head to drive the fastener when the driver is rotated in a first direction. The teeth engage the fastener head when the driver is rotated in an opposite direction to remove the fastener.

### FIELD OF THE INVENTION

This invention relates to drivers for applying torque to threaded fasteners and fasteners compatible with such drivers.

### BACKGROUND

Anyone who has driven threaded fasteners has, at some time, unintentionally stripped the head of a fastener, i.e. deformed the slots or recesses in the head so that it is no longer possible to apply torque to the fastener with a driving tool. A threaded fastener with a stripped head causes any number of well-known difficulties and it is desirable to avoid this situation. While it is possible to strip a head with a manual tool such as a common screwdriver, head stripping is more likely to occur, and occur frequently, when a power tool is used to rotate the driver. It is not always possible to apply sufficient axial force to the tool to maintain the driver engaged with the head of the fastener to deliver the torque necessary to turn and advance it. Power tools, with their capability for high rotational speed and significant torque can very rapidly ruin the head of any fastener as the tool turns against the head, riding in an out of the slots or recesses, without turning the fastener. It is furthermore very difficult to remove a fastener having a stripped head or threads. There is clearly a need for a combination driver and threaded fastener which mitigates the potential for damaging the head of the fastener by stripping and also permits ready removal of fasteners having stripped threads.

### SUMMARY

The invention concerns a driver for applying torque to a threaded fastener. In an example embodiment the driver comprises a body having first and second ends oppositely disposed. A longitudinal axis extends lengthwise along the body between the first and second ends. A plurality of blades are positioned at the first end of the body. Each blade extends lengthwise along and projects away from the longitudinal axis. Each blade has a helical twist about the longitudinal axis. Each blade defines a respective engagement surface on a first side thereof and a respective back surface on a second side thereof oppositely disposed from the first side. Each engagement surface is adapted for engagement with the threaded fastener. At least one of the back surfaces comprises a plurality of teeth projecting transversely to the back surface. By way of example the teeth extend along the at least one back surface in a direction transverse to the longitudinal axis. In a specific example the at least one back surface comprises three the teeth.

By way of example each engagement surface is oriented angularly with respect to the longitudinal axis. In an example embodiment each engagement surface has an orientation angle ranging from 15° to 60° relative to the longitudinal axis. In a particular example each engagement surface has an orientation angle of 30° relative to the longitudinal axis. By way of example, each back surface is oriented angularly with respect to the longitudinal axis. In an example embodiment, each back surface has an orientation angle ranging from 15° to 60° relative to the longitudinal axis. In a particular embodiment, each back surface has an orientation angle of 30° relative to the longitudinal axis. By way of further example, each engagement surface and each back surface is oriented angularly with respect to the longitudinal axis, each back surface having an orientation angle equal to an orientation angle of the engagement surface relative to the longitudinal axis.

In various example embodiment, each engagement surface may comprise a flat surface or a curved surface. The curved surface is selected from the group consisting essentially of convex surfaces and concave surfaces by way of example. Further by way of example, each back surface may comprise a curved surface. The curved surface is selected from the group consisting essentially of convex surfaces and concave surfaces by way of example.

In an example embodiment, a driver may comprise four of the blades. Further by way of example, a driver may comprise three of the blades.

Further by way of example, each blade may comprises an end surface extending between the engagement surface and the back surface. Each end surface has a polygonal perimeter. Each end surface is oriented angularly with respect to the longitudinal axis. Each end surface defines a respective vertex. Each vertex meets at an apex located on the longitudinal axis. In a specific example embodiment, each perimeter comprises a triangle.

An example driver embodiment may further comprise a plurality of second blades positioned at the second end of the body. Each second blade extends lengthwise along and projects away from the longitudinal axis. Each second blade has a helical twist about the longitudinal axis. Each second blade defines a respective second engagement surface on a first side thereof and a respective second back surface on a second side thereof oppositely disposed from the first side of the second blade. Each second engagement surface is adapted for engagement with the threaded fastener. By way of example, at least one second back surface may comprise a plurality of second teeth projecting transversely thereto. In an example embodiment the second teeth extend along the at least one second back surface in a direction transverse to the longitudinal axis. In a particular example, the at least one second back surface comprises three second teeth.

By way of example, the helical twist of each second blade may be in a direction opposite to the helical twist of the first blades. Further by way of example, each second engagement surface is oriented angularly with respect to the longitudinal axis. In an example embodiment, the body has an outer surface. A portion of the outer surface positioned between the first and second ends may comprise a plurality of flat surfaces. An example embodiment may further comprise a groove extending circumferentially around the body. The groove is positioned between the first and second ends.

In an example embodiment, each second blade may further comprise an end surface extending between the second engagement surface and the second back surface. Each end surface has a polygonal perimeter. Each end surface is oriented angularly with respect to the longitudinal axis. Each end surface defines a respective vertex. Each vertex meets at an apex located on the longitudinal axis. In a specific example embodiment each perimeter comprises a triangle. Further by way of example each back surface may comprise the plurality of the teeth.

The invention further encompasses a driver for applying torque to a threaded fastener comprising a body having first and second ends oppositely disposed. A longitudinal axis extends lengthwise along the body between the first and second ends. A plurality of blades are positioned at the first end of the body. Each blade extends lengthwise along and projects away from the longitudinal axis. Each blade has a helical twist about the longitudinal axis. Each blade defines a respective engagement surface on a first side thereof and a respective back surface on a second side thereof oppositely disposed from the first side. Each engagement surface is adapted for engagement with the threaded fastener. Each blade further comprises an end surface extending between the engagement surface and the back surface. Each end surface has a polygonal perimeter. Each end surface is oriented angularly with respect to the longitudinal axis. Each end surface defines a respective vertex. Each vertex meets at an apex located on the longitudinal axis.

### BRIEF DESCRIPTION OF THE DRAWINGS

FIG. 1 is an isometric view of an example driver according to the invention;

FIG. 2 is a side view of a portion of the driver shown in FIG. 1;

FIG. 3 is a side view of a portion of another embodiment of a driver according to the invention;

FIG. 4 is a side view of a portion of another embodiment of a driver according to the invention;

FIG. 5 is an isometric view of another example embodiment of a driver according to the invention; and

FIGS. 6-10 are partial sectional side views showing the example driver of FIG. 1 in use.

### DETAILED DESCRIPTION

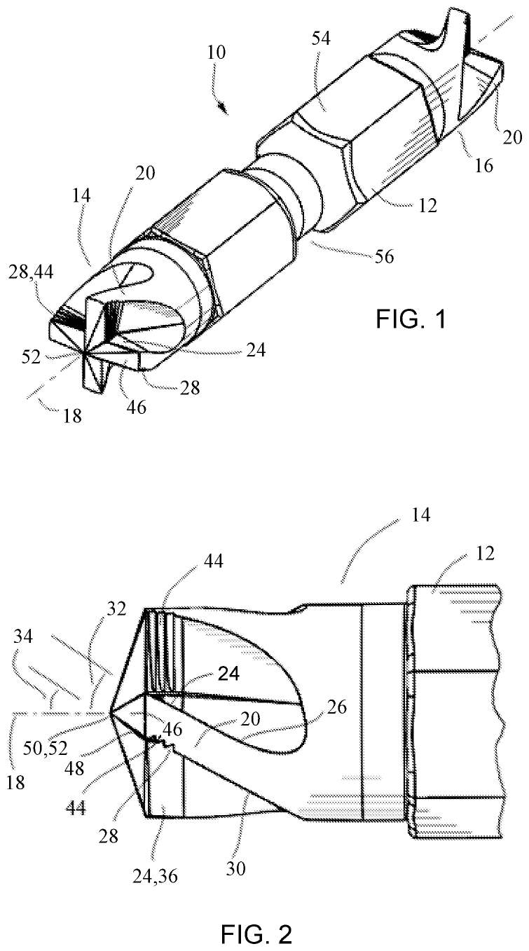

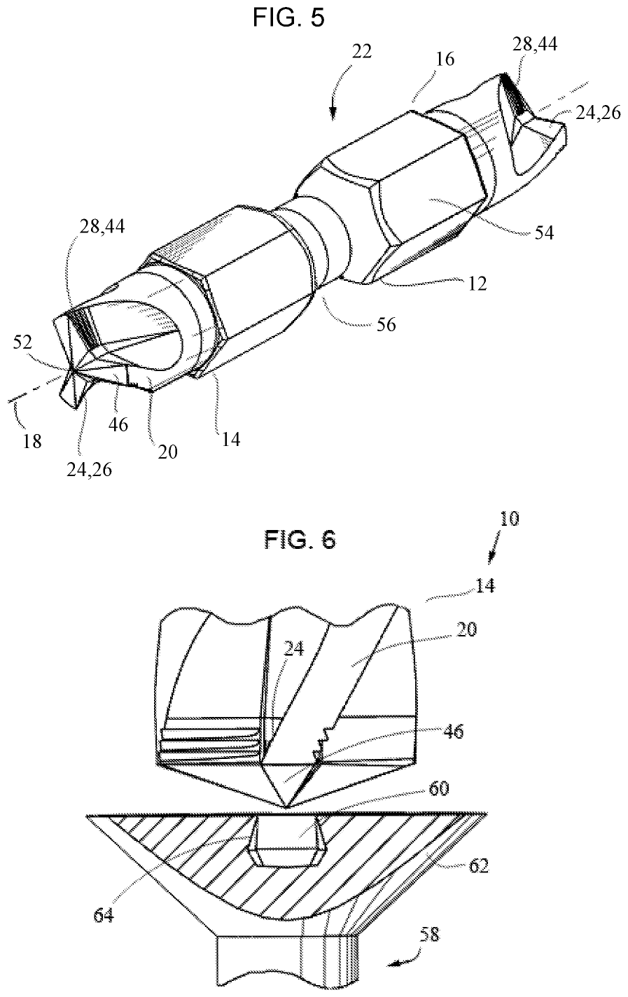

The invention concerns a driver for applying torque to a threaded fastener. FIG. 1 shows an example driver 10 according to the invention, the driver comprising a body 12 having respective first and second ends 14 and 16 oppositely disposed from one another. A longitudinal axis 18 extends lengthwise along the body 12 between the first end 14 and the second end 16. As shown in FIGS. 1 and 2, a plurality of blades 20 are positioned at the first end 14 of the body 12. In this example embodiment there are four blades 20 symmetrically positioned about axis 18. FIG. 5 shows an example driver embodiment 22 having three blades 20. As shown with reference to FIG. 2, each blade 20 extends lengthwise along and projects away from the longitudinal axis 18. Each blade 20 has a helical twist about the longitudinal axis 18. Each blade defines a respective engagement surface 24 on a first side 26 thereof. Each blade 20 also defines a respective back surface 28 on a second side 30 thereof. Second side 30 is oppositely disposed from the first side 26. The engagement surfaces 24 are adapted to engage and drive the threaded fastener as described below. Each engagement surface 24 is oriented angularly with respect to the longitudinal axis 18. In a practical design as shown in FIG. 2, each engagement surface 24 has an orientation angle 32 ranging from about 15° to about 60° relative to the longitudinal axis. An orientation angle 32 of about 30° relative to the longitudinal axis 18 is considered advantageous. As further shown in FIG. 2, each back surface 28 is also oriented angularly with respect to the longitudinal axis 18. In a practical design, each back surface 28 has an orientation angle 34 ranging from about 15° to about 60° relative to the longitudinal axis 18. An orientation angle 34 of about 30° relative to the longitudinal axis 18 is considered advantageous. It is also considered advantageous if each back surface 28 has an orientation angle 34 equal to an orientation angle 32 of the engagement surface 24 relative to the longitudinal axis 18.

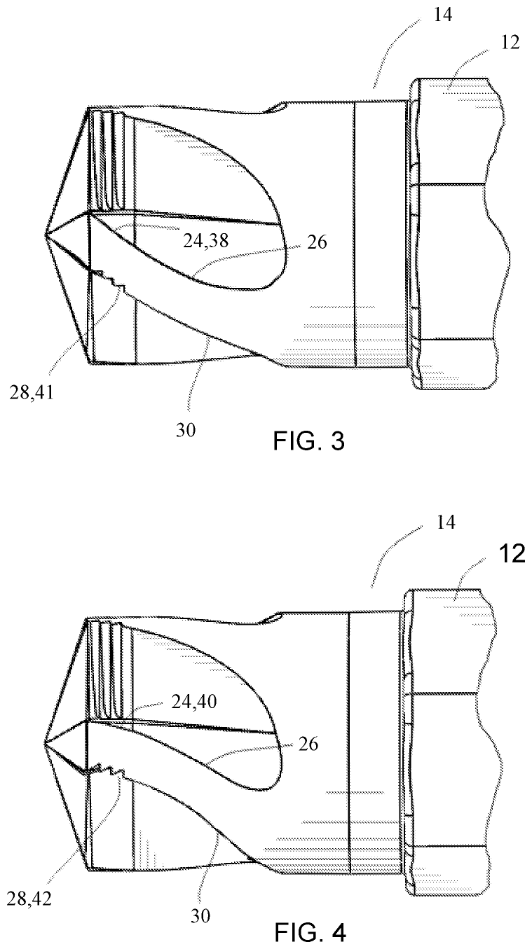

As shown in FIG. 2, each engagement surface 24 may comprise a flat surface 36, although other surface shapes, such as curved surfaces are also feasible. FIG. 3 shows a concave engagement surface 38 and FIG. 4 shows a convex engagement surface 40. Similarly, as shown in FIGS. 3 and 4, each back surface 28 may also comprise a curved surface, a convex back surface 41 being shown in FIG. 3 and a concave back surface 42 being shown in FIG. 4.

In the embodiments 10 and 22 as shown in FIGS. 1 and 5, each back surface 28 comprises a plurality of teeth 44 projecting transversely to the back surface. As shown in FIG. 2, teeth 44 extend along each back surface in a direction transverse to the longitudinal axis 18. In the example embodiments shown the teeth 44 extend perpendicularly to the longitudinal axis 18. By way of example each back surface 28 comprises three teeth 44. Teeth 44 are useful to remove a fastener as described below.

As shown in FIG. 1, each blade 24 of driver 10 may further comprise an end surface 46 extending between the engagement surface 24 and the back surface 28. As shown in FIG. 2, each end surface 46 has a polygonal perimeter 48 (in this example a triangle), and each end surface is oriented angularly with respect to the longitudinal axis 18. Each end surface 46 defines a respective vertex 50, and each vertex of each end surface 46 meets at an apex 52 located on the longitudinal axis 18. End surfaces 46 form a pointed “lead-in” which serves to guide the driver 10 into engagement with the threaded fastener. As shown in FIG. 5, driver embodiment 22 may also have a similar end surface 46.

As further shown in FIG. 1, driver 10 may also comprise a plurality of second blades 20 positioned at the second end 16 of the body 12. The second blades 20 at second end 16 may be identical to the blades 20 at the first end 14 as described above, or, as shown, the helical twist of the blades 20 at the second end 16 may be reversed about the longitudinal axis 18 relatively to blades 20 at the first end 14 of body 12 thereby allowing the driver 10 to be used to both drive and remove threaded fasteners. Body 12 may comprise flat surfaces 54 and a circumferential groove 56 to permit driver 10 to be used as a bit with a powered drill, a driver handle with interchangeable bits, a ratchet or other tool for applying torque. FIG. 5 shows a similar configuration for driver embodiment 22.

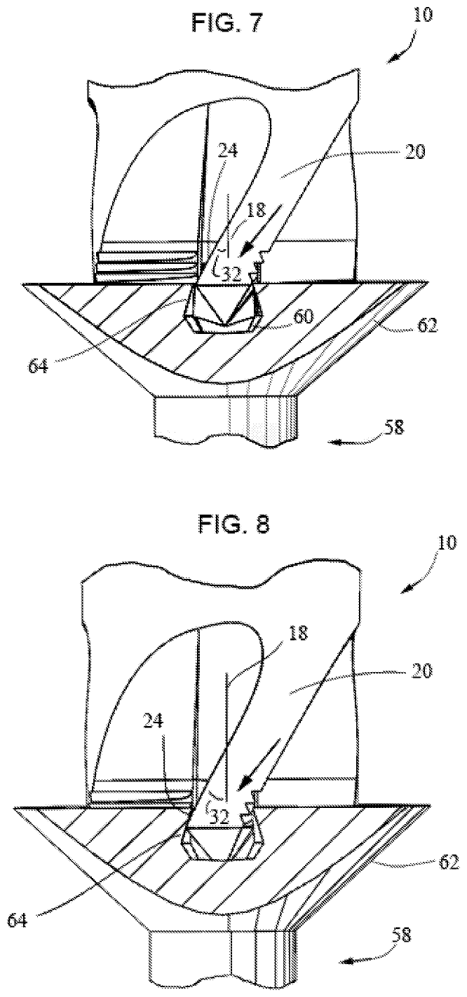

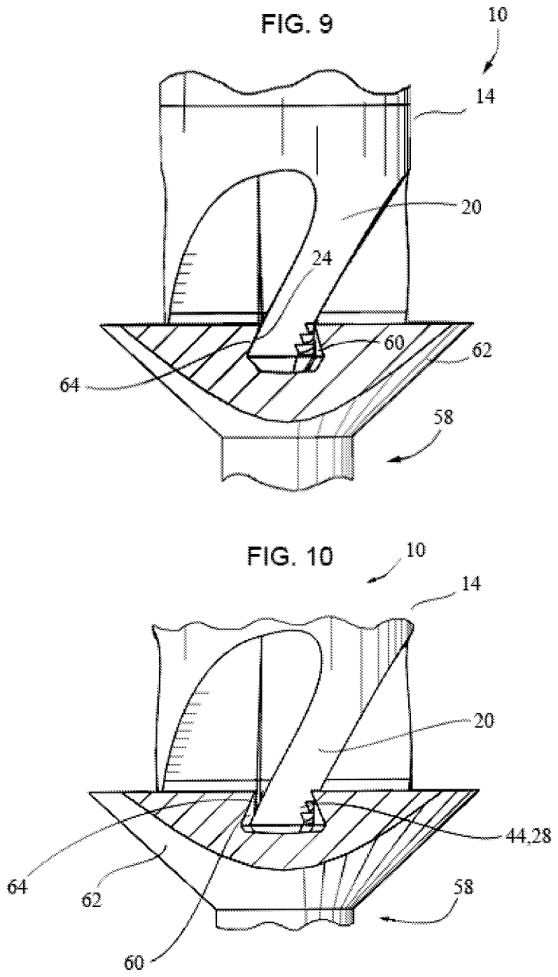

FIGS. 6-10 show example driver 10 being used to drive a compatible threaded fastener 58. FIG. 6 shows the first end 14 of driver 10 approaching recesses 60 within the head 62 of fastener 58. Fastener 58 is compatible with driver 10 in that the recesses 60 have sidewalls comprising faceted surfaces 64 which are oriented so as to engage the engagement surfaces 24 of blades 20. Note that the end surfaces 46 act as a lead-in to guide the first end 14 into the fastener 58. First contact between the engagement surfaces 24 of blades 20 and the faceted surfaces 64 is shown in FIG. 7. Rotation of the driver 10 according to the right hand rule pulls it deeper into the recesses 60 of the fastener 58 through contact action between the engagement surfaces 24 and the faceted surfaces 64 due to the orientation angle 32 of the engagement surfaces as shown in FIG. 8. As shown in FIG. 9, driver 10 is fully seated within the head 62 and further rotation will drive the fastener into a work piece. Should it be desired to withdraw the fastener 58 as shown in FIG. 10, the direction of rotation of the driver 10 is reversed and the teeth 44 on the back surfaces 28 of blades 20 are engaged with the head 62 of fastener 58, the teeth providing purchase to transmit rotation to the fastener.

It is expected that drivers according to the invention will provide advantages when driving threaded fasteners into and withdrawing fasteners from various materials.

1. A driver for applying torque to a threaded fastener, said driver comprising:
a body having first and second ends oppositely disposed, a longitudinal axis extending lengthwise along said body between said first and second ends;
a plurality of blades positioned at said first end of said body, each said blade extending lengthwise along and projecting away from said longitudinal axis, each said blade having a helical twist about said longitudinal axis, each said blade defining a respective engagement surface on a first side thereof and a respective back surface on a second side thereof oppositely disposed from said first side, each said engagement surface adapted for engagement with said threaded fastener, at least one said back surface comprising a plurality of teeth projecting transversely to said back surface.

2. The driver according to claim 1, wherein said teeth extend along said at least one back surface in a direction transverse to said longitudinal axis.

3. The driver according to claim 2, wherein said at least one back surface comprises three said teeth.

4. The driver according to claim 1, wherein each said engagement surface is oriented angularly with respect to said longitudinal axis.

5. The driver according to claim 4, wherein each said engagement surface has an orientation angle ranging from 15° to 60° relative to said longitudinal axis.

6. The driver according to claim 4, wherein each said engagement surface has an orientation angle of 30° relative to said longitudinal axis.

7. The driver according to claim 4, wherein each said back surface is oriented angularly with respect to said longitudinal axis.

8. The driver according to claim 7, wherein each said back surface has an orientation angle ranging from 15° to 60° relative to said longitudinal axis.

9. The driver according to claim 7, wherein each said back surface has an orientation angle of 30° relative to said longitudinal axis.

10. The driver according to claim 1, wherein each said engagement surface and each said back surface is oriented angularly with respect to said longitudinal axis, each said back surface having an orientation angle equal to an orientation angle of said engagement surface relative to said longitudinal axis.

11. The driver according to claim 1, wherein each said engagement surface comprises a flat surface.

12. The driver according to claim 1, wherein each said engagement surface comprises a curved surface.

13. The driver according to claim 12, wherein said curved surface is selected from the group consisting essentially of convex surfaces and concave surfaces.

14. The driver according to claim 1, wherein each said back surface comprises a curved surface.

15. The driver according to claim 14, wherein said curved surface is selected from the group consisting essentially of convex surfaces and concave surfaces.

16. The driver according to claim 1, comprising four of said blades.

17. The driver according to claim 1, comprising three of said blades.

18. The driver according to claim 1, wherein each said blade further comprises an end surface extending between said engagement surface and said back surface, each said end surface having a polygonal perimeter, each said end surface being oriented angularly with respect to said longitudinal axis, each said end surface defining a respective vertex, each said vertex meeting at an apex located on said longitudinal axis.

19. The driver according to claim 18, wherein each said perimeter comprises a triangle.

20. The driver according to claim 1, further comprising a plurality of second blades positioned at said second end of said body, each said second blade extending lengthwise along and projecting away from said longitudinal axis, each said second blade having a helical twist about said longitudinal axis, each said second blade defining a respective second engagement surface on a first side thereof and a respective second back surface on a second side thereof oppositely disposed from said first side of said second blade, each said second engagement surface adapted for engagement with said threaded fastener.

21. The driver according to claim 20, wherein at least one said second back surface comprises a plurality of second teeth projecting transversely thereto.

22. The driver according to claim 21, wherein said second teeth extend along said at least one second back surface in a direction transverse to said longitudinal axis.

23. The driver according to claim 22, wherein said at least one second back surface comprises three said second teeth.

24. The driver according to claim 20, wherein said helical twist of each said second blade is in a direction opposite to said helical twist of said first blades.

25. The driver according to claim 20, where each said second engagement surface is oriented angularly with respect to said longitudinal axis.

26. The driver according to claim 20, wherein said body has an outer surface, a portion of said outer surface positioned between said first and second ends comprising a plurality of flat surfaces.

27. The driver according to claim 26, further comprising a groove extending circumferentially around said body, said groove positioned between said first and second ends.

28. The driver according to claim 20, wherein each said second blade further comprises an end surface extending between said second engagement surface and said second back surface, each said end surface having a polygonal perimeter, each said end surface being oriented angularly with respect to said longitudinal axis, each said end surface defining a respective vertex, each said vertex meeting at an apex located on said longitudinal axis.

29. The driver according to claim 28, wherein each said perimeter comprises a triangle.

30. The driver according to claim 1, wherein each said back surface comprises said plurality of said teeth.

31. A driver for applying torque to a threaded fastener, said driver comprising:
a body having first and second ends oppositely disposed, a longitudinal axis extending lengthwise along said body between said first and second ends;
a plurality of blades positioned at said first end of said body, each said blade extending lengthwise along and projecting away from said longitudinal axis, each said blade having a helical twist about said longitudinal axis, each said blade defining a respective engagement surface on a first side thereof and a respective back surface on a second side thereof oppositely disposed from said first side, each said engagement surface adapted for engagement with said threaded fastener, each said blade further comprises an end surface extending between said engagement surface and said back surface, each said end surface having a polygonal perimeter, each said end surface being oriented angularly with respect to said longitudinal axis, each said end surface defining a respective vertex, each said vertex meeting at an apex located on said longitudinal axis.

32-59. (canceled)
